(19) United States
(12) Patent Application Publication
(10) Pub. No.: US 2024/0269674 A1
(43) Pub. Date: Aug. 15, 2024

(54) FLUIDIC DEVICE FOR FILTERING A FLUID, AND ASSOCIATED METHOD

(71) Applicant: EDEN TECH, PARIS (FR)

(72) Inventors: Emmanuel ROY, PARIS (FR); Cécile PERRAULT, PARIS (FR); Wei ZHAO, PARIS (FR); Jean-Baptiste BLONDE, PARIS (FR); Oscar VALETTE, PARIS (FR); Jules CALVY, SABLONS (FR); Pauli GUNTER, KANAGAWA (JP)

(21) Appl. No.: 18/569,640

(22) PCT Filed: Jun. 13, 2022
(86) PCT No.: PCT/FR2022/051124

§ 371 Date: Dec. 13, 2023

(30) Foreign Application Priority Data
Jun. 14, 2021 (FR) FR2106269

(51) Int. Cl. B01L 3/00

(52) U.S. Cl. CPC B01L 3/502753; B01L 2300/0681; B01L 2300/0864; B01L 2300/087; B01L 2300/0887; B01L 2300/161; B01L 2400/0487; B01L 2400/086

(57) ABSTRACT

A fluidic filtering device designed to filter at least one particle from a fluid, including at least one network of microfluidic channels, the at least one network including: —a main inlet for fluid to be filtered; —a main particle concentrate outlet; —a plurality of filtered-fluid outlets; —a plurality of particle positioning channels; —a plurality of particle concentration channels; —a plurality of filtered-fluid collection channels; —a hydrodynamic resistance balancing structure configured in such a way that the hydrodynamic resistance of each of the filtered-fluid collection channels is defined by a hydrodynamic resistance of the balancing structure and a ratio a between the filtered-fluid volume and the particle concentrate volume at the outlet of each particle concentration channel.

### CROSS REFERENCE TO RELATED APPLICATIONS

This application is a National Stage of International Application No. PCT/FR2022/051124, having an International Filing Date of 13 Jun. 2022, which designated the United States of America, and which International Application was published under PCT Article 21(2) as WO Publication No. 2022/263758 A1, which claims priority from and the benefit of French Patent Application No. 2106269 filed on 14 Jun. 2021, the disclosures of which are incorporated herein by reference in their entireties.

### BACKGROUND

### Field

The present disclosure relates to a fluidic device for filtering a fluid, and an associated filtration method, used for example to filter solid pollutants such as plastic microparticles from water.

### Brief Description of Related Developments

Plastic microparticles, known as microplastics, are particles with a diameter of less than 5 mm. They can be split into primary microplastics and secondary microplastics. Primary microplastics are manufactured so that they are microscopic in size, and the term refers to plastic particles directly added to products, in particular particles for manufacturing plastic products, cosmetics and the microbeads contained in household products. Secondary microplastics result from the fragmentation of large pieces of plastic waste due to physical and/or chemical degradation.

The presence of microplastics in the environment has become a global environmental concern and an increasing problem due to the exponential increase in the production of plastics. Production has not stopped growing on a global scale since the development of the first synthetic polymers in the middle of the 20th century. The main consequence of high plastic production is the generation of large quantities of plastic waste that ends up in the environment, mainly in the marine environment. It is estimated that each year, between 4.8 and 12.7 million metric tons of plastic waste are introduced into the oceans, thus becoming a major environmental problem. According to seawater samples taken, microplastics are estimated to represent up to 94% of plastic waste. Microplastics have been found in almost all ecosystems, inland and oceanic water, sediments, air and soil. Microplastics are also present in organisms, mainly aquatic organisms. The pollution of water by microplastics is an important concern due to the potential damage to both humans and fauna.

The known methods for pretreating microplastic samples currently comprise direct visual inspection, screening, filtration and sink-float density separation. There is currently no standardized method that makes it possible to separate microplastics from water with significant yield. Most methods have drawbacks such as the high cost of the equipment required, the long time necessary to separate the microplastics and the difficulty in implementing the system on an industrial scale to treat large volumes of water.

### SUMMARY

The present disclosure improves this situation.

A fluidic filtration device is proposed, suitable for filtering at least one particle from a fluid, comprising at least one fluidic network of microfluidic channels, said at least one network comprising:
a main inlet for fluid to be filtered connected to a fluidic distribution network for fluid to be filtered;
a main particle concentrate outlet connected to a particle concentrate collection network;
a plurality of filtered fluid outlets connected to a filtered fluid collection network;
a plurality of particle positioning channels, each particle positioning channel comprising an inlet for fluid to be filtered and an outlet for fluid to be filtered, the inlet of the first positioning channel of the plurality of positioning channels forming the main inlet for fluid to be filtered;
a plurality of particle concentration channels, each particle concentration channel extending in a direction of the flow of the fluid to be filtered, each particle concentration channel comprising an inlet for fluid to be filtered, at least one filtered fluid outlet and one particle concentrate outlet, the particle concentrate outlet of the last particle concentration channel of the plurality of particle concentration channels forming the main particle concentrate outlet and the particle concentrate outlet of the other particle concentration channels being in fluidic communication with the inlet for fluid to be filtered of the particle positioning channel, the outlet for fluid to be filtered of each particle positioning channel being in fluidic communication with the inlet for fluid to be filtered of the particle concentration channel;
a plurality of filtered fluid collection channels, each filtered fluid collection channel extending from a particle concentration channel and being in fluidic communication with the filtered fluid outlet of said particle concentration channel;
each positioning channel comprising a plurality of surface modifiers present on the inner wall of the positioning channel, said modifiers being arranged and configured to direct the particles toward a position of the concentration channel inlet so as to generate a stream of particles in the concentration channel as far away as possible from the filtered fluid outlet of the concentration channel;
each particle concentration channel comprising a plurality of surface modifiers present on the inner wall of the particle concentration channel, the plurality of modifiers comprising a first group of modifiers arranged and configured to distance the particles circulating in the concentration channel from the outlet and direct them toward the particle concentrate outlet, and a second group of surface modifiers arranged and configured to prevent the particles from entering the filtered fluid collection channel by forming a barrier at the filtered fluid outlet so that the particle concentration increases as the fluid flows through the particle concentration channels;
a hydrodynamic resistance balancing structure, configured so that the hydrodynamic resistance of each of the filtered fluid collection channels Rᵢ depends solely on the hydrodynamic resistance R₁ and the ratio a between the volume of filtered fluid and the volume of particle concentrate at the outlet of each of the particle concentration channels, said balancing structure extending in the form of a channel from the main particle concentrate outlet of the particle concentration channel.

According to one advantageous aspect, the balancing structure further comprises a plurality of balancing duct segments with different dimensions so as to spread the hydrodynamic resistance R₁ over said particle concentration channel and all of the duct segments.

Preferably, the balancing ducts are formed by one or more particle concentrate collection ducts.

According to another aspect, at least one filtered fluid collection channel of the plurality of filtered fluid collection channels is extended by a plurality of hydrodynamic resistance spreading duct segments with different dimensions so as to spread its hydrodynamic resistance over said at least one filtered fluid collection channel and over said plurality of duct segments.

Preferably, said ducts are formed by one or more filtered fluid collection ducts of the network.

According to one exemplary aspect, the hydrodynamic resistance R₁ of the balancing structure is greater than the hydrodynamic resistance R_{CG} of the greatest of the R_{CG} values of the network by a factor of between 5 and 5,000,000, preferably between 500 and 100,000, the resistance R_{CG} being the sum of the hydrodynamic resistances of the positioning channel and the adjacent particle concentration channel, the positioning channel being the channel preceding the concentration channel with respect to the direction of flow of the fluid.

According to one exemplary aspect, the filtered fluid collection channel has a width of between 0.1 μm and 1,000 μm, a height of between 0.1 μm and 1,000 μm and a length of between 10 μm and 100 mm.

According to one aspect, said at least one network comprises:
a plurality of positioning channels;
a plurality of particle concentration channels each comprising an inlet for fluid to be filtered, two filtered fluid outlets, and a particle concentrate outlet;
a plurality of filtered fluid collection channels extending on either side from the particle concentration channels and in fluidic communication with the two filtered fluid outlets of the particle concentration channel.

According to another aspect, said at least one network comprises:
a plurality of particle concentration channels extending in the direction of the flow of the fluid and arranged parallel to each other, each of the particle concentration channels comprising an inlet, a particle concentration outlet, and a filtered fluid outlet;
a plurality of filtered fluid collection channels, each filtered fluid collection channel extending continuing on from a particle concentration channel and being in fluidic communication with said particle concentration channel;
a plurality of positioning channels, each positioning channel fluidically connecting the particle concentrate outlet of one particle concentration channel with the particle concentration inlet of the subsequent particle concentration channel.

The features disclosed in the following paragraphs can optionally be implemented, independently of one another or in combination with each other:

The surface modifiers comprise bosses, chevrons and/or indentations.

Said bosses extend from a surface of the inner wall toward the opposite wall and/or to the surface of the opposite wall.

According to one aspect, the device comprises a plurality of networks organized in radial symmetry around a distribution duct for fluid to be filtered to form a microfluidic unit.

According to another aspect, the device comprises a stack of layers, each layer comprising a plurality of multifluidic units, one end of the stack comprising a fluid distribution network and the other end of the stack comprising a filtered fluid collection network and a particle concentrate collection network, said distribution duct for fluid to be filtered of each fluidic unit passing through the plurality of layers to supply the main inlet for fluid to be filtered of all of the networks forming the microfluidic unit.

Preferably, said at least one network is dimensioned so that at least 10% by weight of the particles with a volume of between 4.10⁻² and 7.10⁻⁹ m³, present in the fluid to be filtered are collected at the main particle concentrate outlet of the network.

According to another aspect, a filtration assembly is proposed that is suitable for filtering at least one particle from a fluid, comprising a plurality of fluidic devices as defined above, said networks being fluidically connected in series and/or in parallel.

According to one aspect, the assembly comprises twenty fluidic devices, each of the devices forming a stack of one thousand layers having a diameter of 30 cm, each of the layers comprising sixty fluidic units, each of the units comprising sixteen networks organized in radial symmetry around a distribution duct for fluid to be filtered capable of circulating at a flow rate of 100 m³/s at a pressure of 10 bar.

According to another aspect, a filtration system is proposed, comprising:
at least one filtration device as defined above;
a fluid temperature measuring system;
a fluid pH measuring system;
a geolocation system;
a leak or obstruction locating system configured to generate an alarm signal in the event of a leak;
a pressure regulator;
a flow regulator;
an optical system configured to characterize the particles;
an ultrasonic and/or infrared radiation system for determining the nature of the polymer of the particles;
a control system for stopping the filtration device;
a membrane filter or centrifugal filter prefiltration system;
a particle treatment system using an enzymatic, chemical or physical method;
a wireless data transmission system;
a draining and/or cleaning system.

According to yet another aspect, a method is proposed that is suitable for filtering at least one particle from a fluid by implementing the device as defined above, comprising:
a step in which the fluid is introduced into said at least one filtration network with a flow rate of the fluid to be filtered of between 0.01 m³/s and 100 m³/s, said flow rate being such that the Péclet number of the particle in the flow of the fluid travelling the length of said particle concentration channel in the direction of flow is between 1.10² and 1.10²⁰; and
a pressure difference is ensured between the main inlet and the outlets of the device so as to drive said flow into said filtration device, the pressure difference being less than 10 bar.

According to one aspect, the method further comprises, after the filtration step, a washing step in which a fluid for washing the channels forming the microfluidic network is introduced, by closing the main inlet for fluid to be filtered, and reversing the direction of the stream of fluid circulating in said at least one filtration network, converting the filtered fluid outlets into filtered fluid inlets.

### BRIEF DESCRIPTION OF THE DRAWINGS

Further features, details and advantages will become apparent on reading the detailed description below, and on studying the appended drawings, in which:

FIG. 1 schematically shows a filtration device according to one aspect comprising a distribution network for fluid to be filtered, a fluidic filtration network, a particle collection network and a filtered fluid collection network.

FIG. 2 schematically shows a fluidic filtration network according to one aspect.

FIG. 3 schematically shows another depiction of the fluidic network in FIG. 2 with the hydrodynamic resistances associated with each of the filtered fluid collection channels and the hydrodynamic resistance associated with the last particle concentration collection channel at the outlet of the network.

FIG. 4 schematically shows a microfluidic unit according to one aspect comprising twelve fluidic networks from FIG. 2 arranged radially around a distribution duct for fluid to be filtered (a) and an enlarged top view of the central zone of the microfluidic unit (b).

FIG. 5 schematically shows a filtration device according to another aspect, comprising a stack of layers each comprising a plurality of fluidic units, a distribution network for fluid to be filtered positioned at one end of the stack, a filtered fluid collection network and a particle concentrate collection network being positioned at the opposite end of the stack.

FIG. 6 schematically shows an enlarged view of the particle concentrate outlet zone of the fluidic filtration network in FIG. 2 (a), a fluidic unit (b) and a stack of fluidic units fluidically connected to a particle concentrate collection network and a duct outside the stack.

FIG. 7A shows a partially exploded perspective view of a filtration device in which the stack in FIG. 5 is positioned in a housing according to one aspect.

FIG. 7B shows a side view of FIG. 7A.

FIG. 8 schematically shows a filtration network according to another aspect.

FIG. 9A shows a cross-sectional view of a portion of the filtration network in FIG. 2, highlighting the interface (I1) between the outlet for fluid to be filtered of the positioning channel and the inlet for fluid to be filtered of the particle concentration channel, the interface (I2) between the filtered fluid outlet of the concentration channel and the filtered fluid inlet of the filtered fluid collection channel, the interface (I3) between the outlet for fluid to be filtered of the concentration channel and the inlet for fluid to be filtered of the positioning channel, with the presence of indentations in the positioning channel, and the presence of bosses and indentations in the particle concentration channel according to one aspect.

FIG. 9B shows a view of FIG. 9A, illustrating the stream of the particles influenced by the presence of indentations and bosses in the concentration channel and the presence of indentations in the positioning channel according to one aspect.

FIG. 10 schematically shows the different exemplary aspects of surface modifiers made on the inner wall of the positioning channel and/or on the inner wall of the particle concentration channel.

FIG. 11 schematically shows the general architecture of a filtration system.

FIG. 12 schematically shows a network of fluidic filtration devices.

FIG. 13 schematically shows a fluidic particle filtration method.

FIG. 14A shows a view of FIG. 9A during the implementation of the step of washing by reversing the stream of filtered fluid by closing the main inlet for fluid to be filtered and converting the filtered fluid outlets of the filtered fluid collection channels into filtered fluid inlets.

FIG. 14B shows a view of the device in FIG. 7B during the implementation of the step of washing by reversing the stream of filtered fluid.

### DETAILED DESCRIPTION

### Definitions

Within the meaning of the present disclosure, the term “particle” denotes any rigid or soft solid element, which can be a plastic, metal, or mineral particle, or an organic particle such as bacteria, a human, animal or plant cell, a plankton, or a virus. It can take the form of a substantially spherical element, a fiber, or a sheet. The element has a volume of less than 5 mm³.

The term “filter”, and in particular the term “filter at least one particle from a fluid” denotes the treatment making it possible to remove all or some of the particles present in the fluid to be filtered. In other words, the particle-free water of the fluid to be filtered is removed from the concentration channels so as to obtain a particle concentrate at the end of filtration.

The term “length of a channel” denotes the size of the channel in the main direction of flow of the fluid.

“Width of a channel” denotes the maximum size of a channel in a direction transverse to the main direction of flow of the fluid.

“Height of a channel” denotes the minimum size of a channel in a direction transverse to the main direction of flow of the fluid.

The term “particle concentrate” denotes a volume of liquid containing the particles in which the volume of the fluid has been divided by at least 1,000 with respect to the initial volume of the fluid.

“Filtered fluid” denotes a volume of liquid the particle concentration of which is less than the concentration of the concentrate. A filtered fluid can be entirely without particles.

“Two-dimensional network” denotes a network all of the elements of which can be distributed in one plane, but in one row. More particularly, “two-dimensional network of channels” denotes a network of channels in which each channel is distributed in the same plane, regardless of the orientation of each channel. Preferably, the microfluidic channels of the network of the present disclosure form at least one two-dimensional network of channels.

“Three-dimensional network” denotes a network all of the elements of which can be distributed in space, but not in one plane. More particularly, “three-dimensional of channels” denotes a network of channels in which each channel is distributed in space but not in one plane, regardless of the orientation of each channel.

“Hydrodynamic resistance” denotes the ratio between the upstream-downstream pressure difference in a channel or more generally a network of channels or a duct, and the volume flow rate of the fluid passing through the channel or more generally the network of channels or the duct.

The Péclet number Pe makes it possible to characterize the ratio between the transport of a particle by convection and by diffusion, in a microfluidic channel. It is defined by the following relation (1):

$$P e = \frac{L c v}{D} \qquad [ Math . 1 ]$$

Where L_{c} is the characteristic length of the microfluidic channel, and v is the advection velocity of the particle 10. During the implementation of the filtration device according to the present disclosure, the characteristic length is considered to be equal to the length of a microfluidic channel in the main direction of flow of the fluid.

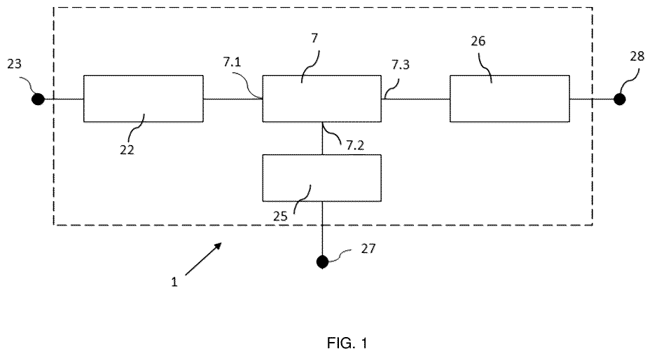

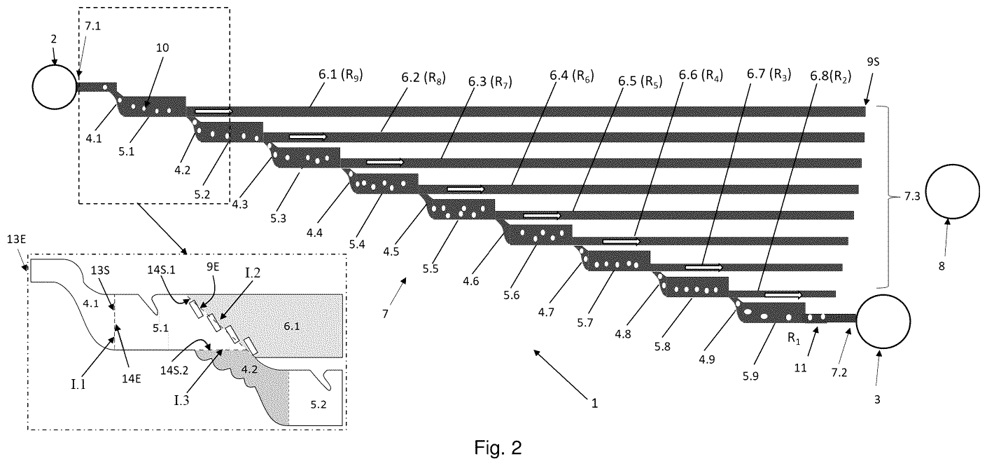

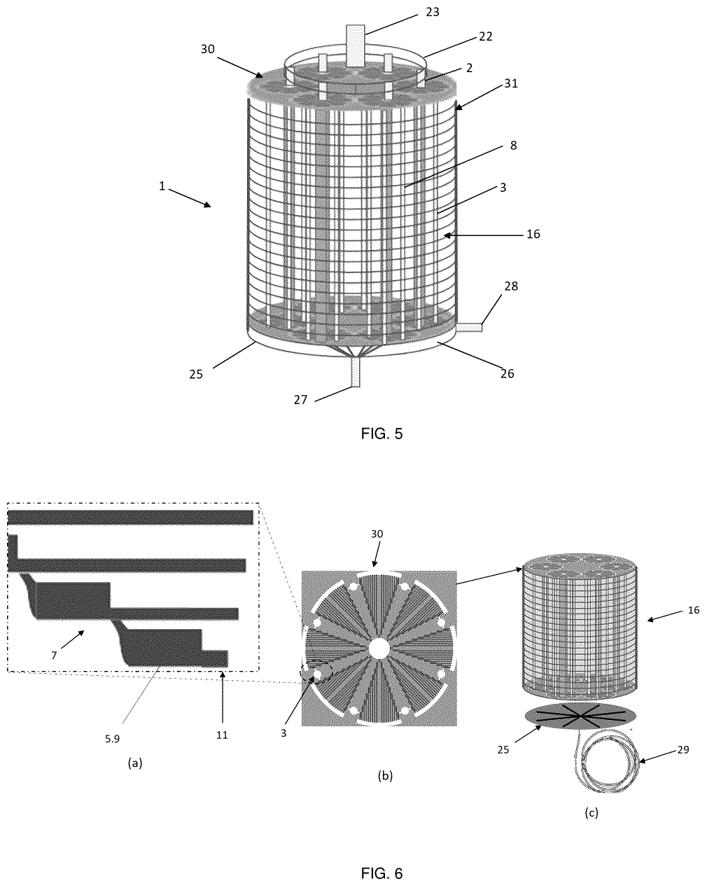

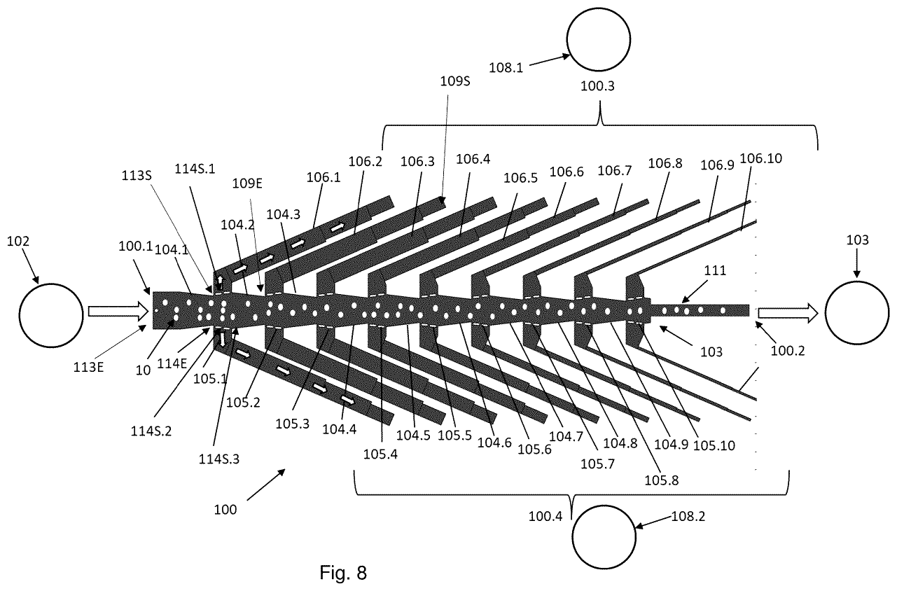

With reference to FIG. 1, the fluidic device 1 according to one aspect can comprise four fluidic networks 22, 7, 25, 26 fluidically connected together. The inlet 23 of the device 1 is connected to a fluidic fluid distribution network 22. The fluidic distribution network 22 is suitable for distributing the fluid to be filtered to the fluidic filtration network 7 the main inlet for fluid to be filtered 7.1 of which is fluidically connected to the distribution network 22. The fluidic filtration network 7 can be a two-dimensional network of microfluidic channels, as shown in FIG. 2 and FIG. 8, or a three-dimensional network of microfluidic channels, as shown in FIG. 5. The fluidic connection between the fluid distribution network for fluid to be filtered 22 and the filtration network 7 can be implemented for example by a plurality of ducts connected to a plurality of inlets of the fluidic filtration network. The filtered fluid outlet 7.3 of the fluidic filtration network 7 is connected upstream to the fluidic filtered fluid collection network 26. The particle concentrate outlet 7.2 of the fluidic filtration network 7 is connected to the fluidic particle concentrate collection network 25. The fluidic connection between the fluidic filtration network 7 and the filtered fluid collection network can be implemented for example by a plurality of filtered fluid outlets of the filtration network connected to a plurality of inlets of the filtered fluid collection network. The fluidic connection between the fluidic filtration network 7 and the particle concentrate collection network 25 can be implemented by a plurality of particle concentrate outlets connected to a plurality of inlets of the particle collection network. The filtered fluid collection network 26 is connected upstream to the filtered fluid outlet 28. The particle collection network 25 is connected upstream to the particle outlet 27.

With reference to FIG. 2, an aspect of the network 7 of microfluidic channels suitable for filtering at least one particle from a fluid is shown. FIG. 2 schematically shows a top view of a set of microfluidic channels. The network comprises a main inlet for fluid to be filtered 7.1, a main particle concentrate outlet 7.2, and a plurality of filtered fluid outlets 7.3.

The network of microfluidic channels 7 comprises three categories of channels depending on their function in the implementation of the filtration of the fluid. The network comprises a plurality of particle positioning channels 4, a plurality of particle concentration channels 5, and a plurality of filtered fluid collection channels 6.

The particle concentration channels 5 and the filtered fluid collection channels 6 extend in a main direction of flow of the fluid. More specifically, the particle concentration channels 5 extend in the main direction of flow of the fluid and are arranged parallel to each other. Each filtered fluid collection channel 6 extends continuing on from a particle concentration channel and is in fluidic communication with the particle concentration channel. The length of each filtered fluid collection channel decreases gradually from the main fluid inlet 7.1 toward the main particle concentrate outlet 7.2. The example of the network shown in FIG. 2 here comprises nine positioning channels 4.1, 4.2, 4.3, 4.4, 4.5, 4.6, 4.7, 4.8, 4.9, nine particle concentration channels 5.1, 5.2, 5.3, 5.4, 5.5, 5.6, 5.7, 5.8, 5.9 and eight filtered fluid collection channels 6.1, 6.2, 6.3, 6.4, 6.5, 6.6, 6.7, 6.8. The number of channels forming the microfluidic network is non-limiting.

The particle concentration channels are fluidically connected to each other in succession by means of a positioning channel.

Each positioning channel comprises an inlet for fluid to be filtered 13E and an outlet for fluid to be filtered 13S. In FIG. 2, the inlet 13E and the outlet 13S are shown only on the first positioning channel 4.1. Within the meaning of the present disclosure, the term “first” denotes the rank of the channel with respect to the main inlet for fluid to be filtered of the network. The inlet 13E of this first positioning channel is connected downstream of the outlet for fluid to be filtered of a distribution duct for fluid to be filtered 2. The inlet 13E of this first positioning channel thus also forms the main inlet for fluid to be filtered 7.1 of the network.

Each concentration channel comprises an inlet for fluid to be filtered 14E and two outlets, a first filtered fluid outlet 14S.1 and a second particle concentrate outlet 14S.2. Each filtered fluid collection channel also comprises a filtered fluid inlet 9E and a filtered fluid outlet 9S. Each particle concentration channel is connected downstream, with respect to the direction of flow of the fluid, of the outlet for fluid to be filtered of the positioning channel. In FIG. 2, the inlet for fluid to be filtered14E of the particle concentration channel 5.1 is in fluidic communication with the outlet for fluid to be filtered 13S of the positioning channel 4.1. The first filtered fluid outlet 14S.1 of the particle concentration channel 5.1 is in fluidic communication with the filtered fluid inlet 9E of the filtered fluid collection channel 6.1. The second particle concentrate outlet 14S.2 of the particle concentration channel 5.1 is connected upstream of the inlet for fluid to be filtered of the positioning channel 4.2. In FIG. 2, the particles 10 are represented by white dots and flow from the main inlet 7.1 of the network to the main particle concentrate outlet 7.2. The fluid to be filtered is thus filtered by flowing in succession through the particle concentration channels, which retain the particles. As a result, the particle concentration increases as the fluid flow through the particle concentration channels. In the example in FIG. 2, the outlet of the last particle concentration channel 5.9 forms the main particle concentrate outlet 7.2, which is connected upstream of a particle collection duct 3. The filtered fluid at the outlet of each filtered fluid collection channel 6 is collected by a filtered fluid collection channel 8.

To better illustrate the fluidic connections between the positioning channel, the concentration channel and the filtered fluid collection channel, FIG. 2 shows an enlarged view of a portion of the filtration network in FIG. 2. More specifically, the enlarged view shows only the first two positioning channels 4.1, 4.2, the first two particle concentration channels 5.1, 5.2, and the first filtered fluid collection channel 6.1.

As described above, the first positioning channel 4.1 comprises an inlet for fluid to be filtered 13E and an outlet for fluid to be filtered 13S. The first concentration channel 5.1 comprises an inlet for fluid to be filtered, a filtered fluid outlet 14S.1 and a particle concentrate outlet 14S.2. The filtered fluid collection channel 6.1 comprises a filtered fluid inlet 9E. The outlet for fluid to be filtered 13S is connected to the inlet for fluid to be filtered 14E, forming an interface I1, shown by a dashed line, between the first positioning channel 4.1 and the first particle concentration channel 5.1. The filtered fluid outlet 14S.1 is connected to the inlet 9E forming an interface 12 between the first concentration channel and the first filtered fluid collection channel. The particle concentrate outlet 14S.2 is connected to the inlet for fluid to be filtered of the second positioning channel forming an interface I3 between the first concentration channel and the second positioning channel.

To be able to ensure the filtration quality as the fluid to filtered flows in succession from the first concentration channel to the last concentration channel of the network, that is, to be able to withdraw only particle-free fluid from each particle concentration channel, the concentration channel comprises a plurality of surface modifiers present on the inner wall of the concentration channel. The plurality of modifiers comprises a first group of modifiers arranged and configured to distance the particles circulating in the concentration channel from the outlet 14S.1 and direct them toward the particle concentrate outlet 14S.2, and a second group of surface modifiers arranged and configured to prevent the particles from entering the filtered fluid collection channel by forming a barrier at the interface 12, as shown in the enlarged view in FIG. 2.

According to one aspect, the positioning channel also comprises a plurality of surface modifiers present on the inner wall of the positioning channel. These modifiers are arranged and configured to direct and/or orient the particles toward a position of the inlet of the concentration channel as far away as possible from the filtered fluid outlet, so as to force the particles to move into a lower zone of the concentration channel.

According to the present disclosure, it is desirable to be able to control the ratio between the volume of filtered fluid collected by the filtered fluid collection channel and the volume of particle concentrate at the outlet of each particle concentration channel, regardless of the geometry and characteristics of the positioning channels and particle concentration channels. In addition, it is essential that the microfluidic filtration network guarantees that as many particles as possible flow toward the particle concentration channel. According to the present disclosure, the distribution of the volume of filtered fluid and the path of the particles can be controlled by balancing the hydrodynamic resistances of the structure of the network, and in particular of each of the channels forming the network.

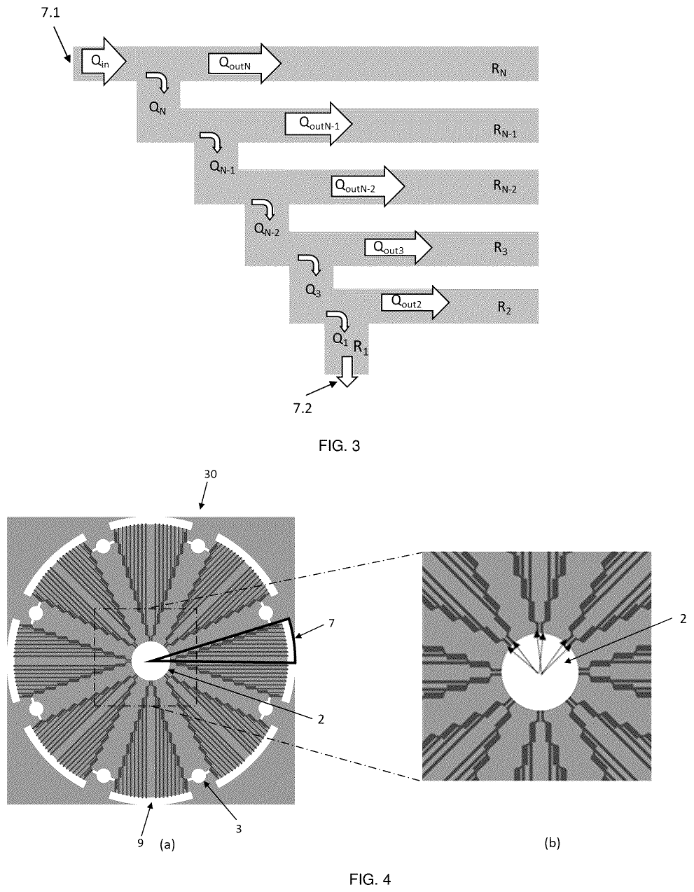

With reference to FIG. 3, which shows a filtration network that comprises N filtered fluid collection channels, the hydrodynamic resistance R_{eqN} of all of the channels forming the network can be defined by the following relation (2):

$${E}_{{eq}_{N}} = {R}_{CG} ( {\sum }_{k = 1}^{N - 1} {a}^{k} ) + {a}^{N - 2} {R}_{1} \qquad [ Math . 2 ]$$

R_{CG} is the sum of the hydrodynamic resistances of the positioning channel (R_{C}) and of the particle concentration channel (R_{G}), the positioning channel being the channel preceding the concentration channel with respect to the direction of flow of the fluid. Thus in FIG. 2 for example, R_{CG} is the sum of the resistances of the positioning channel 4.1 and of the concentration channel 5.1. R_{CG} changes as a function of the geometry and characteristics of the positioning channels and of the concentration channels and as a function of the Reynolds number in the channels. The parameter a is the ratio between the volume of the particle concentrate Q at the outlet of the particle concentration channel and the volume of the filtered fluid at the outlet of the particle concentration channel Qₒᵤₜ. R₁ is the resistance of the last particle concentration channel bearing the main particle concentrate outlet. In FIG. 2, the last particle concentration channel, which has the resistance R₁, is denoted 5.9.

The inventors of the present disclosure have determined, on the basis of relation (2), that when R₁ is greater than the greatest resistance R_{CG} of the R_{CG} values of the network by a certain factor, the distribution does not change regardless of the resistance R_{CG}, in particular when R₁ is greater than R_{CG} by a factor of between 5 and 5,000,000, preferably between 500 and 100,000. If the network comprises different R_{CG} values, they have determined that R₁ must be greater than the greatest resistance R_{CG}. As a result, the resistance R_{CG} is rendered negligible in relation to the resistance R₁ in relation (2).

In order to be able to satisfy this condition, the filtration network of the present disclosure comprises a balancing structure 11 that extends from the particle concentration channel having the resistance R₁. In the exemplary aspect shown in FIG. 2, this balancing structure extends in the form of a channel from the main concentrate outlet of the particle concentration channel 5.9. The balancing structure 11 is connected downstream of the particle concentrate outlet of the particle concentration channel 5.9 and upstream of the particle concentrate collection duct 3. The resistance R₁ is thus spread over the particle concentration channel 5.9 and the channel forming the balancing structure 11. In the example in FIG. 2, the outlet of the balancing structure 11 forms the main particle concentrate outlet 7.2. The dimension of this balancing structure can be adjusted so as to be able to define a resistance R₁ that is sufficiently great to render the resistance R_{CG} negligible.

The hydrodynamic resistance of each of the filtered fluid collection channels is defined by the following relation (3):

$${R}_{i} = \frac{1}{1 - a} ( {R}_{CG} {\sum }_{k = 1}^{i - 1} {a}^{k} + {a}^{i - 1} {R}_{1} ) \qquad [ Math . 3 ]$$

Where Rᵢ is the hydrodynamic resistance of the filtered fluid collection channel, i being an integer between 2 and N. It is evident from relation (2) that it is also possible to determine the resistance of each of the filtered fluid collection channels by defining a resistance R₁ greater than R_{CG} so that the resistance Rᵢ is a function solely of the distribution a and R₁. It is therefore possible to establish a hydrodynamic resistance balance on the basis of these resistances Rᵢ, so as to obtain a stable microfluidic filtration network.

With reference to FIG. 4, a radial architecture can be used to arrange a plurality of microfluidic networks around a distribution duct for fluid to be filtered 2. In the example in FIG. 4, it is thus possible to arrange sixteen microfluidic networks 7 from FIG. 2 about the primary channel 12. This architecture thus forms a microfluidic unit 30. The duct 2 is fluidically connected to all of the inlets of the networks, thus making it possible to distribute the fluid to be filtered to all of the sixteen networks, as shown in the enlarged view of the central zone of the microfluidic unit. The filtered fluid collection outlets 9 of the sixteen networks can be fluidically connected together to at least one filtered fluid collection duct 8. The particle concentrate outlets of the networks can be fluidically connected together to at least one particle concentrate collection duct 3. This radial architecture makes it possible to maximize the surface density occupied by the filtration networks on one layer.

With reference to FIG. 5, a plurality of microfluidic units 30 can also be formed in a single layer 31. In FIG. 5, each layer 31 comprises for example six microfluidic units. The layers can also be stacked on top of each other. FIG. 5 shows a stack 16 of twenty-two layers, each comprising six microfluidic units.

The distribution ducts for fluid to be filtered 2 pass in succession through the layers in order to distribute the fluid to be filtered to the different networks. The particle concentrate 3 and filtered fluid 8 collection ducts pass in succession through the layers to respectively collect the particle concentrate from each layer and the filtered fluid from each layer.

The stack 16 of layers can comprise a distribution channel network for fluid to be filtered 22, a particle concentrate collection network 25 and a filtered fluid collection network 26. These networks can take the form of layers of channels positioned at the ends of the stack. The first layer of the stack thus forms a fluid distribution channel network and the last two layers of the stack respectively form a filtered fluid collection network and a particle collection network. The distribution channel network for fluid to be filtered makes it possible to connect an inlet duct for fluid to be filtered 23 to the distribution ducts 2 passing through the stack. The particle concentrate collection channel network 25 makes it possible to connect a particle concentrate collection duct 27 to the concentrate collection channels 3 passing in succession through the stack. The filtered fluid collection channel network 26 makes it possible to connect a filtered fluid collection duct 28 to the filtered fluid collection channels 8 passing successively through the stack.

With reference to FIG. 6 and as indicated above, the hydrodynamic resistance balancing structure 11 has the function of balancing, or optimally spreading, the hydrodynamic resistances of all of the microfluidic channels of the network 7. It is arranged continuing on from the last particle concentration channel with respect to the direction of flow of the fluid. This last particle concentration channel thus also forms a particle concentrate collection channel the outlet of which also forms the main particle concentrate outlet 7.2 of the network. As shown in the exemplary network in FIG. 2 and image (a) of FIG. 6, which shows an enlarged view of this particle concentrate outlet zone in FIG. 2, the balancing structure 11 extends from the last particle concentration channel 5.9. In FIG. 6, part of this balancing structure is shown in the form of a channel. The hydrodynamic resistance R₁ is thus spread over the channel 5.9 and the balancing structure 11.

According to the present disclosure, it is possible to adjust the dimension of this balancing structure as a function of the hydrodynamic resistance R₁ required to counterbalance the resistance R_{CG}. According to one exemplary aspect, the balancing structure comprises a plurality of balancing duct segments with different dimensions so that the hydrodynamic resistance R₁ can be spread over all of the duct segments.

According to one exemplary aspect and as shown by image (b) in FIG. 6, the balancing ducts are advantageously partially formed by a particle concentrate collection duct 3 connected downstream of the main particle concentrate outlet 7.2 of the network. The hydrodynamic resistance R₁ is thus spread over the particle concentrate collection channel 5.9 and the particle concentrate collection duct 3.

According to another example and as shown by image (c) in FIG. 6, the ducts of the balancing structure are also partially formed by the ducts of the particle concentrate collection network 25 that is located at the end of the stack 16. The hydrodynamic resistance R₁ is thus spread over the particle concentrate collection channel 5.9, the particle concentrate collection duct 3, and the particle concentrate collection network 25.

According to yet another example, the ducts of the balancing structure are partially formed by a duct 29 arranged outside the network. The hydrodynamic resistance R₁ is in this case spread over the particle concentrate collection channel 5.9, the particle concentrate collection duct 3, the particle concentrate collection network 25 and the duct 29.

According to one exemplary aspect, to avoid the technical constraints of microfabrication and in order to satisfy the hydrodynamic resistances Rᵢ calculated for the different filtered fluid collection channels, it is also possible to extend the filtered fluid collection channels of the duct segments with different dimensions so as to be able to spread the resistance over the corresponding fluid collection channel and one or more duct segments. These duct segments can be present and form part of the network 7. By way of example, these ducts are partially formed in particular by the filtered fluid collection duct passing through the stack and/or by the filtered fluid collection ducts of the network 26 situated at the end of the stack 16. According to one variant, these segments can be formed by hoses arranged outside the network 7, as in the example shown in image (c) of FIG. 6.

Generally, the shape of the cross-section of a positioning channel, a particle concentration channel and a filtered fluid collection channel can be circular, rectangular or any other geometric shape.

The length of a filtered fluid collection channel can be between 0.01 mm and 100 mm, preferably between 0.1 mm and 50 mm, and preferably between 1 mm and 20 mm. The width of a filtered fluid collection channel can be between 0.1 μm and 2,000 μm, preferably between 5 μm and 1,000 μm, and preferably between 100 μm and 500 μm. The height of the filtered fluid collection channel can be between 0.1 μm and 2,000 μm, preferably between 5 μm and 1,000 μm, and preferably between 100 μm and 500 μm. Generally, a microfluidic channel can have several heights.

The length of a particle concentration channel can be between 10 μm and 10,000 μm, preferably between 50 μm and 1,000 μm, and preferably between 200 μm and 500 μm. The width of the particle concentration channel can be between 50 μm and 10,000 μm, preferably between 100 μm and 5,000 μm, and preferably between 500 μm and 1,200 μm. The height of the particle concentration channel can be between 50 μm and 10,000 μm, preferably between 100 μm and 5,000 μm, and preferably between 400 μm and 800 μm.

The length of a positioning channel can be between 10 μm and 10,000 μm, preferably between 50 μm and 1,000 μm, and preferably between 200 μm and 500 μm. The width of the positioning channel can be between 50 μm and 10,000 μm, preferably between 100 μm and 5,000 μm, and preferably between 500 μm and 1,200 μm. The height of the positioning channel can be between 50 μm and 10,000 μm, preferably between 100 μm and 5,000 μm, and preferably between 400 μm and 800 μm.

Generally, the microfluidic channels can be made from PDMS, PFPE, or any other known material suitable for the microfabrication of microfluidic channels. The microfabrication techniques can be UV lithography printing or 3D printing technologies to produce the patterns.

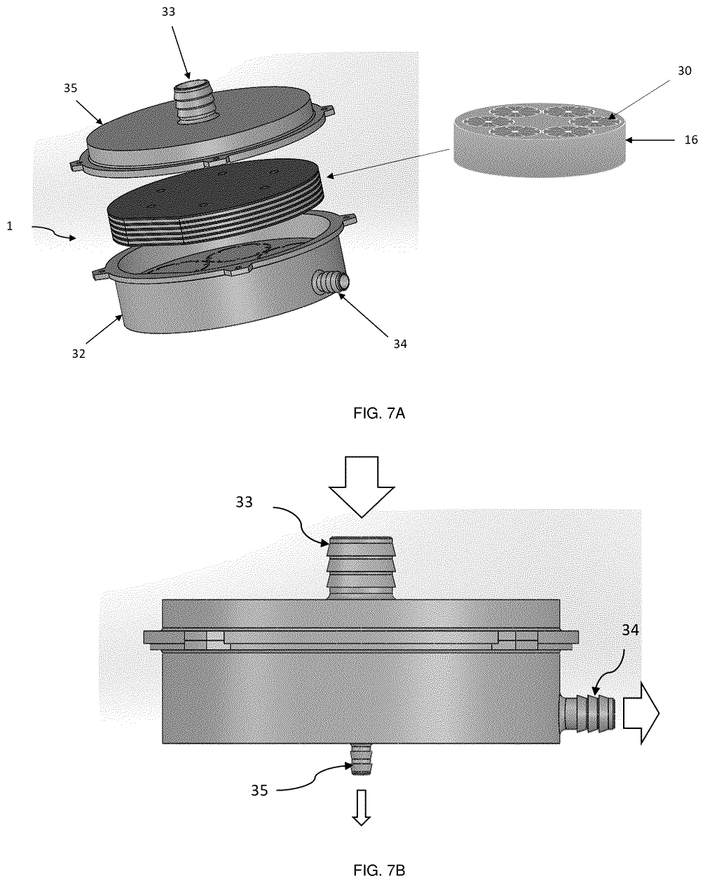

With reference to FIGS. 7A and 7B, the filtration network in the form of a stack 16 in FIG. 5 can be positioned inside a housing. The housing comprises a receptacle 32 in which the stack 16 is positioned, and a cap 35 for closing the receptacle 32. The cap comprises a distribution connector for the fluid to be filtered 33 connected to the inlet duct for fluid to be filtered 23 of the stack. The receptacle 32 comprises a filtered fluid outlet connector 34 connected to the filtered fluid collection duct 28 of the stack 16. The receptacle 32 comprises a concentrate outlet connector 35 connected to the outlet of the particle concentrate collection duct 27 of the stack.

With reference to FIG. 8, another geometric shape of the microfluidic filtration network is shown. The network 100 of microfluidic channels also comprises three categories of channel according to their function in the implementation of the filtration of the fluid. The network 100 comprises a plurality of positioning channels 104.1, 104.2, 104.3, 104.4, 104.5, 104.6, 104.7, 104.8, 104.9, a plurality of particle concentration channels 105.1, 105.1, 105.3, 105.4, 105.5, 105.6, 105.7, 105.8, 105.9, 105.10, and a plurality of filtered fluid collection channels 106.1, 106.2, 106.1, 106.4, 106.5, 106.6, 106.7, 106.8, 106.9, 106.10. The network comprises a main fluid inlet 100.1, a main particle concentrate outlet 100.2 and a plurality of filtered fluid outlets 100.3, 100.4. The example of the network shown in FIG. 8 here comprises nine positioning channels, ten particle concentration channels, and twenty filtered fluid collection channels. The number of channels forming the microfluidic network is non-limiting.

The concentration channels 105 extend in a main direction of flow of the fluid and are arranged one after the other. Each of the filtered fluid collection channels 106 extends from a particle concentration channel and is in fluidic communication with the particle concentration channel.

Each positioning channel comprises an inlet for fluid to be filtered and an outlet for fluid to be filtered. In FIG. 8, the inlet 113E and the outlet 113S are shown only on the first positioning channel 104.1. The inlet 113E of this first positioning channel is connected downstream of the outlet for fluid to be filtered of a distribution duct for fluid to be filtered 102. The inlet 113E of this first positioning channel thus forms the main inlet for fluid to be filtered 100.1 of the network. Each concentration channel comprises an inlet for fluid to be filtered114E and three outlets, two filtered fluid outlets 114S.1, 114S.2, and a third particle concentrate outlet 114S.3. Each filtered fluid collection channel also comprises a filtered fluid inlet 109E and a filtered fluid outlet 109S. Each particle concentration channel is connected downstream, with respect to the direction of flow of the fluid, of the outlet for fluid to be filtered of the positioning channel. In FIG. 8, the fluid inlet 114E of the particle concentration channel 105.1 is in fluidic communication with the fluid outlet 113S of the positioning channel 104.1. The first filtered fluid outlet 114S.1 of the particle concentration channel 105.1 is in fluidic communication with the filtered fluid inlet 109E of the filtered fluid collection channel 106.1. The second filtered fluid outlet 114S.2 of the particle concentration channel 105.1 is in fluidic communication with the filtered fluid inlet 109E of another filtered fluid collection channel. The third particle concentrate outlet 114S.3 of the particle concentration channel is connected upstream of the inlet for fluid to be filtered of the subsequent positioning channel 104.2. In FIG. 8, the particles 10 are represented by white dots and flow from the main inlet 100.1 of the network to the main particle concentrate outlet 100.2. The fluid to be filtered is thus filtered by flowing in succession through the positioning channels and the particle concentration channels, which retain the particles. In the example in FIG. 8, the outlet of the last particle concentration channel 105.10 forms the main particle concentrate outlet 100.2, which is connected upstream of a particle collection duct 103. The filtered fluid at the outlet of each filtered fluid collection channel 106 is collected by two filtered fluid collection channels 108.1, 108.2.

In the example shown in FIG. 8, the network further comprises a hydrodynamic resistance stabilization structure 111, which extends from the last particle concentration channel 105.10. This structure 111 is configured so that it counterbalances the hydrodynamic resistances of the microfluidic channels of the network, in other words, so that it renders the resistance R_{CG} negligible in relation to the resistance R₁. The shape of the inner wall of the positioning channel and the particle concentration channel thus does not change the Reynolds number.

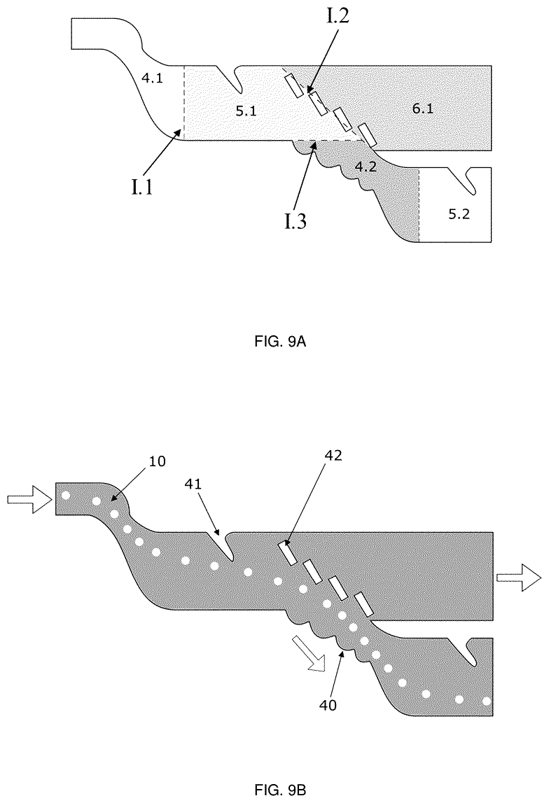

With reference to FIGS. 9A and 9B, the inner walls of the positioning channels and of the concentration channels are structured and modified in order to increase the filtration efficiency. These modifications have been made possible due to the presence of the stabilization structure.

According to one exemplary aspect, the inner wall of the particle concentration channel can comprise a plurality of surface modifiers that are arranged and configured to distance the particles circulating in the concentration channel from the filtered fluid outlet and direct them toward the particle concentrate outlet, and to block the passage of the particles in order to prevent them from heading toward the inlet of the filtered fluid collection channels.

According to another exemplary aspect, the inner wall of the positioning channel comprises a plurality of modifiers that are arranged and configured to direct the particles to a desired position with respect to the inlet of the particle concentration channel in order to force them to circulate in a lower zone of the concentration channel so as to distance them from the filtered fluid inlet of the filtered fluid collection channels. These modifiers also make it possible to align the particles with the direction of flow of the fluid to facilitate the movement of the particles in the concentration channels.

FIG. 9A shows the enlarged view of the filtration network in FIG. 2, showing only the first positioning channel 4.1, the first particle concentration channel 5.1, the second particle concentration channel 5.2, the first filtered fluid collection channel 6.1, connected to the filtered fluid outlet of the first concentration channel, and the second positioning channel 4.2, connected to the concentrate outlet of the first particle concentration channel 5.1. In FIG. 9A, the interface between the first positioning channel 4.1 and the first particle concentration channel 5.1 is represented by a dashed line and denoted I1, the interface between the first concentration channel 5.1 and the first filtered fluid collection channel 6.1 is represented by a dashed line and denoted I2, and the interface between the first concentration channel 5.1 and the second positioning channel 4.2 is represented by a dashed line and denoted I3.

To be able to ensure the filtration quality as the fluid to be filtered flows in succession from the first concentration channel to the last concentration channel of the network, that is, to be able to withdraw only particle-free fluid from each particle concentration channel, the concentration channel comprises a plurality of surface modifiers present on the inner wall of the concentration channel. The plurality of modifiers comprises a first group of modifiers arranged and configured to distance the particles circulating in the concentration channel from the outlet 14S.1 and direct them toward the particle concentrate outlet 14S.2, and a second group of surface modifiers arranged and configured to prevent particles from entering the filtered fluid collection channel by forming a barrier at the interface I2.

According to one particularly advantageous aspect, the positioning channel also comprises a plurality of surface modifiers present on the inner wall of the positioning channel. These modifiers are arranged and configured to direct and orient the particles toward a position of the inlet of the concentration channel so as to generate a stream of particles only in a lower zone of the concentration channel, and to thus distance the particles from the filtered fluid outlet of the concentration channel.

The impact of the presence of these surface modifiers on the stream of particles is described below with reference to FIG. 9B.

In FIG. 9, the positioning channel 4.2 comprises surface modifiers in the form for example of indentations 40, which make it possible to direct the particles toward a position of the inlet of the concentration channel so as to force the particles to move in a lower zone of the concentration channel, and to distance the particles from the filtered fluid inlet of the filtered fluid collection channel, as shown in FIG. 9B. The particles are therefore guided so that they move in the lower part of the concentration channel so that they head toward the concentrate outlet.

The concentration channel 5.1 comprises a first group of modifiers for example in the form of indentations 41 that have the function of distancing the particles circulating in the concentration channel from the outlet 14S.1 and directing them toward the particle concentrate outlet 14S.2.

The channel also comprises a second group of modifiers in the form of bosses 42 that form a barrier at the interface I2 to prevent the particles from heading toward the filtered fluid inlet of the filtered fluid collection channel 6.1. The combination of the functions performed by all of the modifiers makes it possible to ensure that particle-free fluid is withdrawn from each concentration channel and to increasingly concentrate the particle concentrate as the fluid flows through the concentration channels.

The shapes of the surface modifiers are non-limiting. They can comprise bosses, chevrons, indentations or a combination of these shapes. According to one aspect, the bosses extend from a surface of the inner wall toward the opposite wall and/or to the surface of the opposite wall.

Preferably, the bosses have a height of between 50 and 500 μm and are spaced apart by a distance of between 10 and 500 μm. According to one exemplary aspect, the bosses can have a height substantially equal to the height of the channel. According to another exemplary aspect, the bosses have a height equal to a partial height of the channel.

Preferably, the indentations have a dimension of between 10 and 250 μm and are spaced apart by a distance of between 10 and 500 μm. The indentations can take the form of a protrusion 41 from an inner wall of the concentration channel or of a recess 40 in the inner wall of the positioning channel.

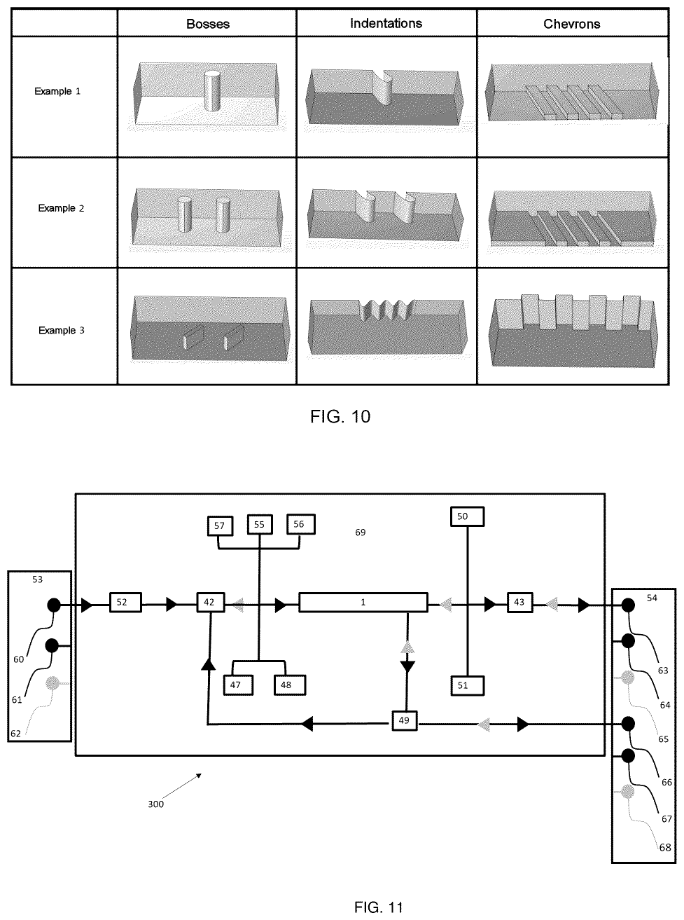

FIG. 10 schematically shows the different possible examples of surface modifiers, in the form of bosses, indentations or chevrons.

Preferably, the network is dimensioned so that at least 10% by weight of the particles with a volume of between 4.10⁻²⁵ and 7.10⁻⁹ m³, present in the fluid to be filtered are collected at the particle concentrate outlet.

FIG. 11 schematically shows the general architecture of a filtration system. The system 300 comprises a frame 69, which comprises at least one fluidic filtration device 1. The system can comprise, downstream of the filtration system 1, an ultrasonic radiation system for determining the nature of the polymer of the particles 49, 50, and an optical system 50 configured to characterize the particles present in the fluid at the outlet of the filtration device 1. Upstream of the filtration device 1, the filtration system comprises a temperature measuring system 47 that makes it possible to measure the temperature of the fluid, a geolocation system 48 that makes it possible to locate the filtration device when it is implemented in a natural environment, a fluid pH measuring system 56, a flow regulator 55 that makes it possible to control the flow rate of the fluid in the filtration system, and a pressure regulator 57. The flow regulator 55 makes it possible to adjust the flow rate so as to drive a fluid flow rate into the filtration system of between 0.1 L·min⁻¹ and 1^{e}8 L·min⁻¹.

The pressure regulator 57 can control a fluid flow rate by pressure difference inside the fluidic device. Upstream of the inlet for fluid to be filtered of the device, the system comprises a membrane filter or centrifugal prefiltration system 42 so as to leave only particles having a diameter suitable for being filtered in the filtration device.

The different arrows show the direction of the possible flows of the fluids in the system.

Advantageously, the system comprises a particle treatment system 43 situated at the outlet of the filtration device in order to treat the particles with an enzymatic solution, for example.

Advantageously, the system comprises an inlet selection valve 53 and an outlet selection valve 54. The selection valve 53 makes it possible to control the inlet for fluid to be filtered 60, the acid/enzymatic solution inlet 61, and the washing outlet 62. The selection valve 54 makes it possible to control the particle outlet 63, the acid/enzymatic solution outlet 64, the washing fluid inlet 65, the filtered fluid outlet 66, the acid/enzymatic solution outlet 67, and the washing fluid inlet 68. The two selection valves 53, 54 are suitable for redirecting the different fluids upstream and downstream of the fluidic device 1 in order to allow recirculation of the fluid.

Advantageously, the system comprises a control system 52 that makes it possible to stop filtration if necessary.

The system comprises a control unit that is electrically connected to the flow regulator, the pressure regulator, and the selection valves. The control unit can for example be a computer comprising a microprocessor, a memory, and a display unit. Data communications between the control unit and the components of the filtration system can be implemented by a wireless data transmission system. The data allows closed-loop control of the recirculation of the fluids in the system.

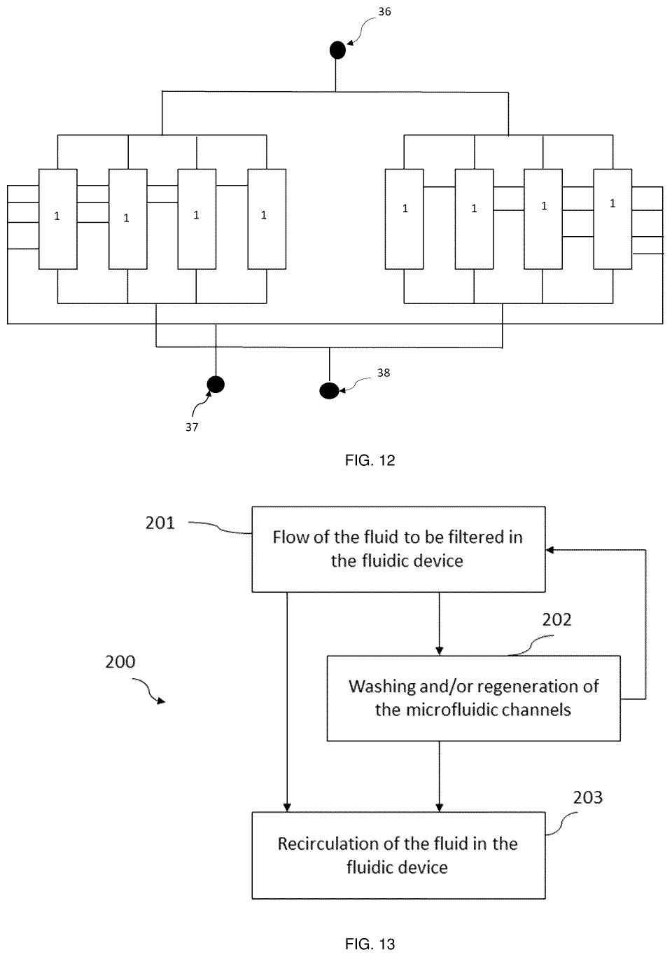

With reference to FIG. 12, a filtration assembly can comprise several fluidic devices 1. The different fluidic devices 1 can be arranged in parallel, as shown in FIG. 12. The assembly can treat a fluid at a higher flow rate than a system comprising a single fluidic device 1. In one aspect, not shown, different fluidic devices can be connected in series. An assembly can for example comprise between two and twenty fluidic devices, preferably between three and ten fluidic devices.

FIG. 12 schematically shows a system comprising eight fluidic devices fluidically connected in parallel. A fluid to be filtered comprising particles is introduced at the inlet of the system 36. A network of fluidic connections connects the inlet 36 to each of the inlets of the devices 1. The filtered fluid is collected at the outlet of the devices. A network of fluidic connections connects each of the filtered fluid outlets of the devices to the outlet 37. The particle concentrate is collected at the outlet of the devices. A network of fluidic connections connects each of the of particle concentrate outlets of the devices to the outlet 38.

According to one aspect, the filtration assembly can comprise twenty fluidic devices that are connected together in parallel or in series. Each device comprises one thousand fluidic layers that have a diameter of 30 cm and can operate with an inlet pressure of 1 bar and a flow rate of 1 m³/s. Each layer comprises sixty fluidic units. Each unit comprises sixteen networks. Such a fluidic assembly can treat fluid at a flow rate of 100 m³/s at a pressure of 10 bar.

With reference to FIG. 13, the method 200 for filtering a fluid comprising particles can comprise several steps.

During a step 201, a fluid to be filtered is introduced into a network of microfluidic channels 7 at a flow rate for the fluid to be filtered. The speed of the flow of the fluid to be filtered, or its flow rate, can be controlled by a pressure regulator. The value of the flow rate can be calculated as a function of the geometry of the different channels of the network and as function of the pressure applied. A flow of fluid the flow rate for the fluid to be filtered of which is between 1 m³/s and 100 m³/s is thus controlled. The flow rate is selected so that the Péclet number of the particle in the flow of the fluid travelling the length of said particle concentration channel in the direction of flow is between 27.10² and 25.10²⁰. In step 201, a pressure difference of less than 10 bar between the main inlet and the outlets of the device is controlled so as to drive an appropriate flow rate into said filtration device.

During a step 202, the washing of the microfluidic channels is controlled as described above and shown in FIG. 11. According to one aspect, the washing step 202 can be carried out several times during the process of filtering a given volume of fluid to be filtered by interrupting the filtration process. This regular washing makes it possible to maintain the filtration quality of the device. It is thus possible to adjust the number of washes as a function of the volume of fluid to be filtered.

During a step 203, the fluid to be filtered is recirculated in the filtration device. The recirculation can be implemented by recirculating the fluid in the same direction as during the first circulation of the fluid, or in the opposite direction.

According to another aspect, the washing step 202 consists of reversing the direction of the stream in the filtration device. To this end, the main inlet for fluid to be filtered is closed. The direction of circulation of the stream of fluid circulating in the filtration network is reversed. In other words, the filtered fluid outlets of the channels are converted into filtered fluid inlets. All of the particles trapped in the concentration channels by the presence of the surface modifiers, for example the bosses at the filtered fluid outlet, are thus released under the effect of the stream of fluid coming from the filtered fluid collection channels.

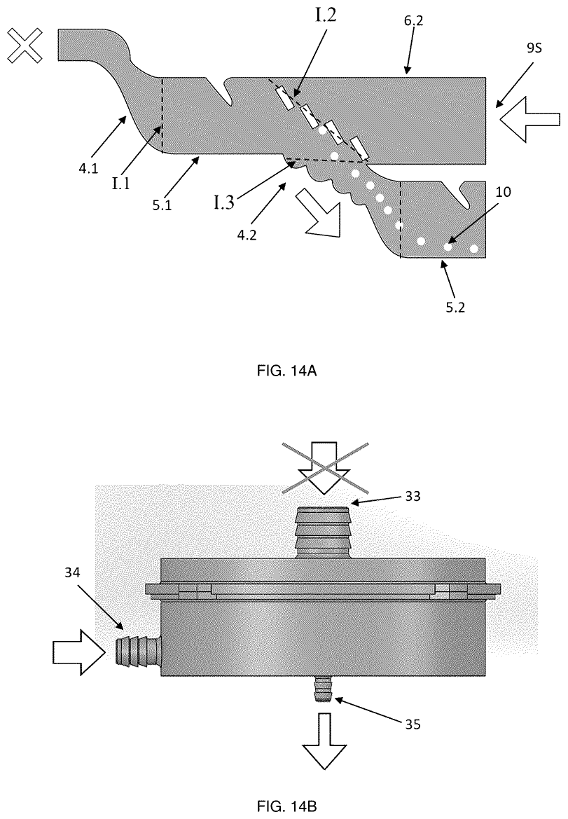

FIG. 14A shows an enlarged view of the filtration network in FIG. 2, showing by way of example the first positioning channel 4.1, the first particle concentration channel 5.1, the second particle concentration channel 5.2, the first filtered fluid collection channel 6.1, connected to the filtered fluid outlet 14S.1 of the first concentration channel, and the second positioning channel 4.2, connected to the concentrate outlet 14S.2 of the first particle concentration channel. To implement the washing of the network, the main inlet for fluid to be filtered is closed. The direction of the stream of fluid shown in FIG. 14A by an arrow is reversed so that the filtered fluid outlet of the filtered fluid collection channel is converted, in the context of washing, into a filtered fluid inlet. Under the effect of the stream of filtered fluid, the particles 10 represented by white dots are trapped in the concentration channel 5.1 by the presence of the surface modifiers, for example the bosses 42, situated at the filtered fluid outlet 14S.1 of the particle concentration channel 5.1, at the interface I2 between the particle concentration channel 5.1 and the filtered fluid collection channel 6.1, are released and moved toward the second particle concentration channel 5.2.

FIG. 14B shows a general view of the housing in which a stack 16 of layers is positioned. During the implementation of the washing step, the inlet for fluid to be filtered at the connector 33 is closed. The direction of the stream is reversed at the filtered fluid outlet connector 34 so as to convert the filtered fluid outlet into a filtered fluid inlet in order to clean all of the filtration networks by releasing the particles trapped on the bosses in each of the concentration channels and direct them toward the particle concentrate outlet.

### Example of Filtration

Microparticles were concentrated in a volume of water in a fluidic concentration device.

In order to circulate a volume of 10 L/min in a device comprising 480 fluidic filtration devices, limiting the pressure loss to 0.2 bar, the general hydraulic resistance of each device must not exceed 2.8^{e}11 Pa·s/m³.

A study of the distribution that splits the fluid volume entering into filtered fluid and fluid with microparticles, as a function of the addition of surface modifiers, was established. The distribution a corresponds to the ratio between the volume of filtered fluid at the outlet of the particle concentration channel and the volume of particle concentrate at the outlet of the particle concentration channel. Devices with channels with geometries such that R₁/R_{CG}<100 and R₁/R_{CG}>100 were defined. One or two surface modifiers, in the form of bosses and in the form of indentations, were then added in these channels. When R₁/R_{CG}<100, the variations of the distribution a at each branch fluctuate enormously, with a standard deviation of 236%, whereas when R₁/R_{CG}>100, this standard deviation is just 25%.

The circulation of fluid+microparticles, with a concentration of 100 microparticles per mL, was observed in a device comprising eight filtered fluid collection channels, nine positioning channels and nine concentration channels, the last of which is a concentrate collection channel 5.9 in FIG. 2 comprising the main particle concentrate outlet, the stream imposed being 10.31 mL/min (velocity of 1.2 m/s). In the concentration channels, three pillars with a diameter of 50 microns, passing across the entire channel, were positioned with a distance of 50 microns between each one. 100% of spherical particles with dimensions greater than 150 microns were correctly conveyed toward the microparticle collection channel, whereas only 75% of particles with dimensions less than 150 microns were correctly conveyed. It was observed that the positioning of the small-diameter particles at the inlet of the concentration channel played a crucial role for the satisfactory operation of the device. When an array of bosses was added in the positioning channel, the particles with a diameter of between 50 and 150 microns were correctly directed toward the concentrate collection channel. During the circulation of particles with the same volume, but different shapes (spheres, fibers, or sheets), it was observed that the arrangements of surface modifiers that made it possible to convey the spherical particles toward the microparticle collection channel did not make it possible to convey the microparticles with the same volume but a different shape. It was thus observed that the conveyance was dependent on the Péclet number of the microparticle, which is linked to the volume of the particles.

TABLE 1

| Shape | | | | | |
|---|---|---|---|---|---|
| Sphere A | | Sphere B | | Fiber A | |
| Dimensions | | | | | |
| Diameter | | Diameter | | Diameter (m) | 50 × 10⁻⁶ |
| (m) | 100 × 10⁻⁶ | (m) | 57.3 × 10⁻⁶ | Length (m) | 100 × 10⁻⁶ |

| | | | |
|---|---|---|---|
| Diffusion coefficient | 4.42 × 10⁻¹⁵ | 6.13 × 10⁻¹⁵ | 6.13 × 10⁻¹⁵ |
| (m²/s) | | | |
| Péclet number | 2.71 × 10¹⁰ | 1.41 × 10¹⁰ | 1.41 × 10¹⁰ |

The results show that the particles in the form of fibers have rotational movements that made it more difficult to convey them toward the microparticle collection channel. These rotational movements are minimized by the presence of a network of bosses arranged in the positioning channel. The bosses were thus able to orient the fibers in line with the flow of the fluid.

What is claimed is:

1. A fluidic filtering device, suitable for filtering at least one particle from a fluid, comprising at least one fluidic network of microfluidic channels, said at least one network comprising:
a main inlet for fluid to be filtered connected to a fluidic network for distributing the fluid to be filtered;
a main particle concentrate outlet connected to a particle concentrate collection network;
a plurality of filtered fluid outlets connected to a filtered fluid collection network;
a plurality of particle positioning channels, each particle positioning channel comprise an inlet for fluid to be filtered and an outlet for fluid to be filtered, the inlet for fluid of the first positioning channel of the plurality of positioning channels forming the main inlet for fluid to be filtered;
a plurality of particle concentration channels, each particle concentration channel extending in a direction of the flow of the fluid to be filtered, each concentration channel comprising an inlet for fluid to be filtered, at least one filtered fluid outlet and one particle concentrate outlet, the particle concentrate outlet of the last particle concentration channel of the plurality of particle concentration channels forming the main particle concentrate outlet and the particle concentrate outlet of the other particle concentration channels being in fluidic communication with the inlet for fluid to be filtered of the positioning channel, the fluid outlet of each particle positioning channel being in fluidic communication with the inlet for fluid to be filtered of the particle concentration channel;
a plurality of filtered fluid collection channels, each filtered fluid collection channel extending from a particle concentration channel and being in fluidic communication with the filtered fluid outlet of said particle concentration channel;
each positioning channel comprising a plurality of surface modifiers present on the inner wall of the positioning channel, said modifiers being arranged and configured to direct the particles toward a position of the concentration channel inlet so as to generate a stream of particles in the concentration channel as far away as possible from the filtered fluid outlet of the concentration channel;
each particle concentration channel comprising a plurality of surface modifiers present on the inner wall of the particle concentration channel, the plurality of modifiers comprising a first group of modifiers arranged and configured to distance the particles circulating in the concentration channel from the filtered fluid outlet and direct them toward the particle concentrate outlet, and a second group of surface modifiers arranged and configured to prevent the particles from entering the filtered fluid collection channel by forming a barrier at the filtered fluid outlet so that the particle concentration increases as the fluid flows through the particle concentration channels;
a hydrodynamic resistance balancing structure, configured so that the hydrodynamic resistance of each of the filtered fluid collection channels Rᵢ depends solely on the hydrodynamic resistance R₁ and the ratio a between the volume of filtered fluid and the volume of particle concentrate at the outlet of each of the particle concentration channels;
said balancing structure extending in the form of a channel from the main particle concentrate outlet of the particle concentration channel.

2. The device as claimed in claim 2, in which the balancing structure further comprises a plurality of balancing duct segments with different dimensions to spread the hydrodynamic resistance R₁ over said particle concentration channel and all of the duct segments.

3. The device as claimed in claim 2, in which the balancing ducts are formed by one or more particle concentrate collection ducts.

4. The device as claimed in claim 1, in which at least one filtered fluid collection channel of the plurality of filtered fluid collection channels is extended by a plurality of hydrodynamic resistance spreading duct segments with different dimensions so as to spread its hydrodynamic resistance over said at least one filtered fluid collection channel and over said plurality of duct segments.

5. The device as claimed in claim 4, in which said ducts are formed by one or more filtered fluid collection ducts.

6. The device as claimed in claim 1, in which the hydrodynamic resistance R₁ of the balancing structure (11) is greater than the hydrodynamic resistance R_{CG} of the greatest of the R_{CG} values of the network by a factor of between 5 and 5,000,000, preferably between 500 and 100,000, the resistance R_{CG} being the sum of the hydrodynamic resistances of the positioning channel and the adjacent particle concentration channel, the positioning channel being the channel preceding the concentration channel with respect to the direction of flow of the fluid.

7. The device as claimed in claim 1, in which the filtered fluid collection channel has a width of between 0.1 μm and 1,000 μm, a height of between 0.1 μm and 1,000 μm and a length of between 10 μm and 100 mm.

8. The device as claimed claim 1, in which said at least one network (100) comprises:
a plurality of positioning channels;
a plurality of particle concentration channels each comprising an inlet for fluid to be filtered, two filtered fluid outlets, and a particle concentrate outlet;
a plurality of filtered fluid collection channels extending on either side from the particle concentration channels and in fluidic communication with the two filtered fluid outlets of the particle concentration channel.

9. The device as claimed in claim 1, in which said at least one network comprises:
a plurality of particle concentration channels extending in the direction of the flow of the fluid and arranged parallel to each other, each of the particle concentration channels comprising an inlet, a particle concentration outlet, and a filtered fluid outlet;
a plurality of filtered fluid collection channels, each filtered fluid collection channel extending continuing on from a particle concentration channel and being in fluidic communication with said particle concentration channel;
a plurality of positioning channels, each positioning channel fluidically connecting the particle concentrate outlet of one particle concentration channel with the particle concentration inlet of the subsequent particle concentration channel.

10. The device as claimed in claim 1, in which the surface modifiers comprise bosses, chevrons and/or indentations.

11. The device as claimed in claim 10, in which said bosses extend from a surface of the inner wall toward the opposite wall and/or to the surface of the opposite wall.

12. The device as claimed in claim 1, comprising a plurality of networks organized in radial symmetry around a distribution duct for fluid to be filtered to form a microfluidic unit.

13. The device as claimed in claim 12, comprising a stack of layers each comprising a plurality of multifluidic units, one end of the stack comprising a fluid distribution network and the other end of the stack comprising a filtered fluid collection network and a particle concentrate collection network, said distribution duct for fluid to be filtered of each fluidic unit passing through the plurality of layers to supply the main inlet for fluid to be filtered of all of the networks forming the microfluidic unit.

14. The device as claimed in claim 1, in which said at least one network is dimensioned so that at least 10% by weight of the particles with a volume of between 4.10⁻²⁵ and 7.10⁻⁹ m³, present in the fluid to be filtered are collected at the particle concentrate outlet.

15. A filtration assembly suitable for filtering at least one particle from a fluid, comprising a plurality of fluidic devices as claimed in claim 1, said networks being fluidically connected in series and/or in parallel.

16. The assembly as claimed in claim 15, comprising twenty fluidic devices, each of the devices forming a stack of one thousand layers having a diameter of 30 cm, each of the layers comprising sixty fluidic units, each of the units comprising sixteen networks organized in radial symmetry around a distribution duct for fluid to be filtered capable of circulating at a flow rate of 100 m³/s at a pressure of 10 bar.

17. A filtration system comprising:
at least one filtration device as claimed in claim 1;
a fluid temperature measuring system;
a fluid pH measuring system;
a geolocation system;
a leak or obstruction locating system configured to generate an alarm signal in the event of a leak;
a pressure regulator;
a flow regulator;
an optical system configured to characterize the particles;
an ultrasonic and/or infrared radiation system for determining the nature of the polymer of the particles;
a control system for stopping the filtration device;
a membrane filter or centrifugal filter prefiltration system;
a particle treatment system using an enzymatic, chemical or physical method;
a wireless data transmission system;
a draining and/or cleaning system.

18. A filtration method suitable for filtering at least one particle from a fluid by implementing the device as claimed in claim 1, comprising:
a step in which the fluid is introduced into said at least one filtration network with a flow rate of the fluid to be filtered of between 0.01 m³/s and 100 m³/s, said flow rate being such that the Péclet number of the particle in the flow of the fluid travelling the length of said particle concentration channel in the direction of flow is between 1.10² and 1.10²⁰; and
a pressure difference is ensured between the main inlet and the outlets of the device so as to drive said flow rate into said filtration device, the pressure difference being less than 10 bar.

19. The method as claimed in claim 18, further comprising, after the filtration step, a washing step in which a fluid for washing the channels forming the microfluidic network is introduced, by closing the main inlet for fluid to be filtered, and reversing the direction of the stream of fluid circulating in said at least one filtration network, converting the filtered fluid outlets into filtered fluid inlets.
